(19) United States
(12) Patent Application Publication
(10) Pub. No.: US 2024/0289941 A1
(43) Pub. Date: Aug. 29, 2024

(54) APPEARANCE INSPECTION DEVICE, APPEARANCE INSPECTION METHOD, AND APPEARANCE INSPECTION PROGRAM

(71) Applicant: NEC Corporation, Minato-ku, Tokyo (JP)

(72) Inventors: Yuka OSHIMA, Tokyo (JP); Takuroh KASHIMA, Tokyo (JP); Yusuke KOITABASHI, Tokyo (JP); Atsushi MATSUDA, Tokyo (JP)

(73) Assignee: NEC Corporation, Minato-ku, Tokyo (JP)

(21) Appl. No.: 17/768,612

(22) PCT Filed: Oct. 5, 2020
(86) PCT No.: PCT/JP2020/037746

§ 371 Date: Apr. 13, 2022

(30) Foreign Application Priority Data
Oct. 23, 2019 (JP) 2019-192625

(51) Int. Cl. G06T 7/00; G06T 7/62

(52) U.S. Cl. CPC G06T 7/0008; G06T 7/62; G06T 2207/30156; G06T 2207/30204

(57) ABSTRACT

A conversion equation calculation unit 81 calculates, based on a defect image with marker in which a marker of a predetermined size that can be recognized regardless of color of appearance of an object to be inspected and a defect of the object to be inspected are taken, a conversion equation from size of the defect image with marker to actual size. A defect type determination unit 82 determines, by using a model for detecting the defect of the object to be inspected from an image and determining a defect type, the defect type included in the defect image with marker. A defect measuring unit 83 measures defect size included in the defect image with marker by using the conversion equation. A defect content output unit 84 outputs the determined defect type and the measured defect size.

### TECHNICAL FIELD

The present invention relates to an appearance inspection device, an appearance inspection method, and an appearance inspection program for inspecting the appearance of products.

### BACKGROUND ART

Painted products, such as automobile bodies, can have various defects during the manufacturing and distribution processes of the products. For example, unevenness in the paint due to such as dust bites in the painting line, uneven color in the paint, and scratches such as during the painting process or during transportation are examples of defects. Generally, such defects are inspected at the time of manufacture or before the product is sold by the dealer.

For example, Patent Literature 1 describes a surface inspection device for inspecting defects on the surface of automobiles. The surface inspection device described in Patent Literature 1 irradiates light onto the inspected surface of the object to be inspected, forms a light- receiving image based on the reflected light from the inspected surface, and detects defects present on the inspected surface based on the light-receiving image.

### CITATION LIST

### Patent Literature

Patent Literature 1: Japanese Patent Application Laid-Open No. H11-63959

### SUMMARY OF INVENTION

### Technical Problem

In the surface inspection device described in Patent Literature 1, a light-receiving image is formed on the manufacturing line to detect defects. In other words, by placing this surface inspection device at a specific position in the manufacturing line, it is possible to obtain the defect location, the contents of the defect, and the size of the defect, etc.

On the other hand, when the appearance of a product is inspected at a place far from the manufacturing line (for example, at a dealer, etc.), defects are usually detected manually. For example, when a defect is detected at such as a dealer, an image of the defect location is taken manually at the dealer, and the manufacturer (maker) who obtains the image determines the type and size of the defect from the image, generally. However, unlike the manufacturing line, the situation in which the defect is taken is not fixed, so the image of the defect taken differs depending on the position and angle at which the defect is taken. Therefore, it takes a lot of time to determine the contents of the defect from such images.

It is difficult to introduce a surface inspection device such as that described in Patent Literature 1 to individual dealers. Therefore, it is desirable to be able to obtain images including defects by a simple method and to automate the process of inspecting the contents of the defects, such as the type and size of the defects, using the images.

Therefore, it is an exemplary object of the present invention to provide an appearance inspection device, an appearance inspection method, and an appearance inspection program capable of reducing the man-hours for inspect the contents of defects occurred in the appearance of an object to be inspected from images including defects that can be obtained by a simple method.

### Solution to Problem

An appearance inspection device according to the exemplary aspect of the present invention includes conversion equation calculation means which calculates, based on a defect image with marker in which a marker of a predetermined size that can be recognized regardless of color of appearance of an object to be inspected and a defect of the object to be inspected are taken, a conversion equation from size of the defect image with marker to actual size, defect type determination means which determines, by using a model for detecting the defect of the object to be inspected from an image and determining a defect type, the defect type included in the defect image with marker, defect measuring means which measures defect size included in the defect image with marker by using the conversion equation, and defect content output means which outputs the determined defect type and the measured defect size.

An appearance inspection method according to the exemplary aspect of the present invention includes calculating, based on a defect image with marker in which a marker of a predetermined size that can be recognized regardless of color of appearance of an object to be inspected and a defect of the object to be inspected are taken, a conversion equation from size of the defect image with marker to actual size, determining, by using a model for detecting the defect of the object to be inspected from an image and determining a defect type, the defect type included in the defect image with marker, measuring defect size included in the defect image with marker by using the conversion equation, and outputting the determined defect type and the measured defect size.

An appearance inspection program according to the exemplary aspect of the present invention causes a computer to execute conversion equation calculation process of calculating, based on a defect image with marker in which a marker of a predetermined size that can be recognized regardless of color of appearance of an object to be inspected and a defect of the object to be inspected are taken, a conversion equation from size of the defect image with marker to actual size, defect type determination process of determining, by using a model for detecting the defect of the object to be inspected from an image and determining a defect type, the defect type included in the defect image with marker, defect measuring process of measuring defect size included in the defect image with marker by using the conversion equation, and defect content output process of outputting the determined defect type and the measured defect size.

### Advantageous Effects of Invention

According to the exemplary aspect of the present invention, it is possible to reduce the

man-hours for inspect the contents of defects occurred in the appearance of an object to be inspected from images including defects that can be obtained by a simple method.

### BRIEF DESCRIPTION OF DRAWINGS

FIG. 1 It depicts a block diagram showing a configuration example of the first exemplary embodiment of an appearance inspection device according to the present invention.

FIG. 2 It depicts an explanatory diagram showing an example of a marker.

FIG. 3 It depicts an explanatory diagram showing an example of the process of taking a defect image with marker.

FIG. 4 It depicts a flowchart showing an operation example of the appearance inspection device of the first exemplary embodiment.

FIG. 5 It depicts a block diagram showing a configuration example of the second exemplary embodiment of an appearance inspection device according to the present invention.

FIG. 6 It depicts a flowchart showing an operation example of the appearance inspection device of the second exemplary embodiment.

FIG. 7 It depicts a block diagram showing an overview of the appearance inspection device according to the present invention.

### DESCRIPTION OF EMBODIMENTS

Hereinafter, exemplary embodiments of the present invention are described with reference to the drawings.

### Exemplary Embodiment 1

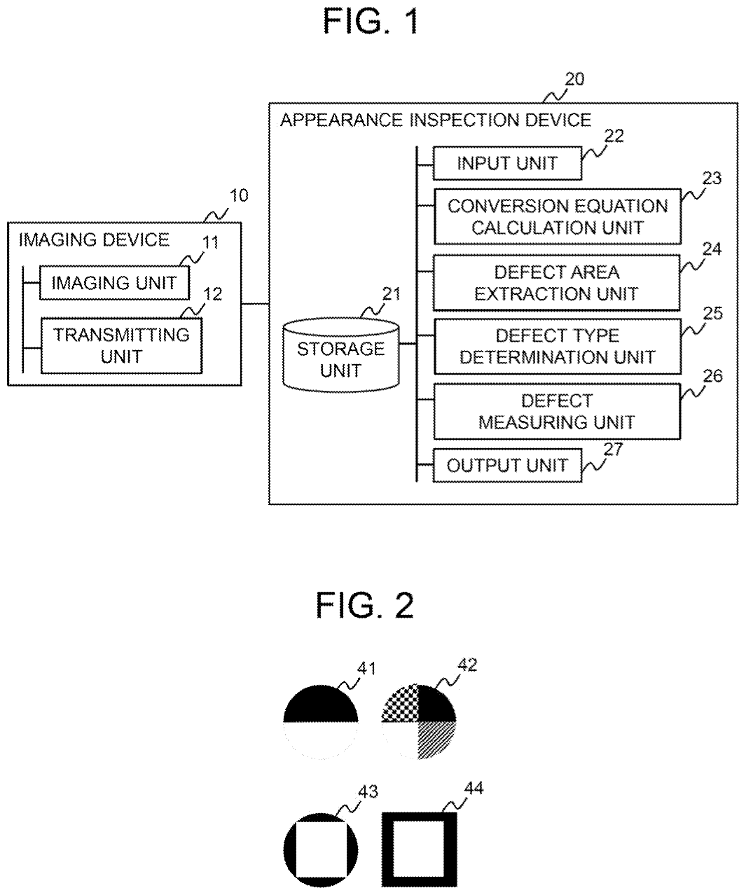

FIG. 1 is a block diagram showing a configuration example of the first exemplary embodiment of an appearance inspection device according to the present invention. An appearance inspection device 20 of this exemplary embodiment is connected to an imaging device 10 via a communication network.

The imaging device 10 is a device that takes the appearance of an object to be inspected and generates images. The imaging device 10 includes an imaging unit 11 and a transmitting unit 12. As a precondition for taking the appearance of the object to be inspected, a marker is attached by the user in the vicinity of a defect occurred in the object to be inspected. The vicinity of the defect indicates a position that does not overlap the defect and is within a predetermined distance from the defect, for example, within 1 cm from the defect.

The marker to be attached is a marker of a predetermined size that can be recognized regardless of the color of the appearance of the object to be inspected. For example, if the object to be inspected is a car, the marker to be attached is a recognizable marker regardless of the body color (painted color), and its size is predetermined. Since the image including the marker and the defect of the object to be inspected is taken by the imaging unit 11, the size of the marker should be equivalent to the size of the defect that can occur, for example, the marker is formed as a square of about 2 cm in length and width or a circle of about 2 cm in diameter.

FIG. 2 is an explanatory diagram showing an example of a marker. The markers shown in FIG. 2 are examples of markers that can be recognized regardless of the color of the appearance of the object to be inspected. Marker 41 is a circular marker that utilizes two colors, with each semicircle represented by a different color. Marker 42 is a circular marker that utilizes four colors, with each of the four equal parts of the circle represented by a different color. Marker 43 is a marker in which the square area inscribed in the circle and the non-square area within the circle are each represented by a different color. Marker 44 is a marker in which a smaller square is placed inside the square, and the area of the inner square and the area of the outer square excluding the area of the inner square are each represented by a different color.

The marker shown in FIG. 2 is an example, and the manner of the marker is not limited to what is illustrated in FIG. 2. Specifically, the marker is formed in such a way that two or more colors are used, and at least two colors each can be used to identify part or all of a square or circle. Due to the drawing display, the markers illustrated in FIG. 2 are displayed in white and black or white and black shading, but white or black and the shaded area may be represented by colors other than black and white, respectively.

As a marker, it is preferable that a manner that facilitates the calculation of the conversion equation by the conversion equation calculation unit 23 described below is used. For example, by using marker 41 or marker 42 as illustrated in FIG. 2, it is possible to use the diameter for the derivation of the conversion equation. Also, for example, by using marker 43 or marker 44 as illustrated in FIG. 2, it is possible to use the length of one side of the center square to derive the conversion equation.

The imaging unit 11 takes an image in which the above marker and the defect of the object to be inspected are taken. The image in which the marker and the defect of the object to be inspected are taken is hereinafter referred to as a defect image with marker. In other words, a defect image with marker is an image taken with a marker attached in the vicinity of the defect.

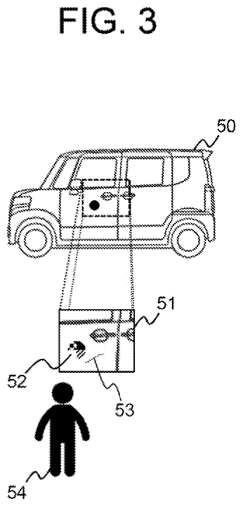

FIG. 3 is an explanatory diagram showing an example of the process of taking a defect image with marker. As illustrated in FIG. 3, a marker 52 is attached by a user 54 in the vicinity of a defect 53 of an automobile 50, which is an object to be inspected, and the imaging unit 11 takes the defect image with marker 51 by taking a close-up image of the defect and the marker according to the user's operation.

The transmitting unit 12 transmits the defect image with marker to the appearance inspection device 20.

The appearance inspection device 20 includes a storage unit 21, an input unit 22, a conversion equation calculation unit 23, a defect area extraction unit 24, a defect type determination unit 25, a defect measuring unit 26, and an output unit 27.

The storage unit 21 stores various information necessary for the appearance inspection device 20 to perform processing. Specifically, the storage unit 21 stores a model used for processing by the defect type determination unit 25 described below: The model used in this exemplary embodiment is a model for detecting defects in the object to be inspected from the image and determining the defect type, and the model generated in advance by machine learning or the like is stored in the storage unit 21. The learning method used to generate the model is arbitrary, and the manner of the model is not limited. The storage unit 21 may also store the features of the marker to be attached.

The input unit 22 receives the input of the defect image with marker taken by the imaging device 10. The input unit 22 may receive the input of the defect image with marker directly from the transmitting unit 12 of the imaging device 10, or may receive the input of the defect image with marker via a storage (not shown).

The conversion equation calculation unit 23 calculates a conversion equation from the size of the defect image with marker to actual size based on the defect image with marker. Specifically: the conversion equation calculation unit 23 calculates the ratio of the actual size to one pixel in the image based on the defect image with marker. The conversion equation calculation unit 23 may, for example. calculate a conversion equation between a pixel in the image and its actual size (for example, in mm).

In this exemplary embodiment. the size of the marker included in the defect image with marker is predetermined. Therefore. the conversion equation calculation unit 23 can extract how many pixels the predetermined size of the marker is represented by in the image, and calculate the conversion equation based on the correspondence between the extracted number of pixels and the size of the marker.

The defect area extraction unit 24 extracts from the defect image with marker an image that includes the marker and is within a predetermined area from the marker as an image including the defect part. For example. the defect area extraction unit 24 predetermines an area within several hundred pixels in length and width from the center of the marker as the extraction area. and the defect area extraction unit 24 may extract the images within the area from the center of the marker as the image including the defect part from the defect image with marker.

Depending on the shape of the object to be inspected. the different contents from the actual state of the object to be inspected may be taken due to the reflection of disturbing light. etc. For example, the body of an automobile includes an R shape, so when a wide area including a defect is taken, the disturbing light may be appeared to the image. On the other hand, in this exemplary embodiment, the defect area extraction unit 24 extracts the image including the defect part, the defect type determination unit 25, which is described below, can improve the accuracy of determining the defect.

If the defect image with marker is an image that is taken within an appropriate area, there is no need to extract the image including the defect part again. Therefore, in this case, the appearance inspection device 20 does not need to include the defect area extraction unit 24.

The defect type determination unit 25 determines the type of defect included in the defect image with marker by using a model stored in the storage unit 21 (i.e., a model that detects a defect in the object to be inspected from the image and determines the defect type). If an image including a defect part is extracted by the defect area extraction unit 24, the defect type determination unit 25 may determine the type of defect included in the extracted image.

The defect measuring unit 26 measures the defect size included in the defect image with marker by using the conversion equation calculated by the conversion equation calculation unit 23. For example, if the object to be inspected has a flaw as a defect, the defect measuring unit 26 may use the conversion equation to measure the length of the flaw included in the defect image with marker.

The output unit 27 outputs the determined defect type and the measured defect size. The output unit 27 may display the type and size of the defect on a display device (not shown), or may notify a predetermined destination by e-mail or other means.

The input unit 22, the conversion equation calculation unit 23, the defect area extraction unit 24, the defect type determination unit 25, the defect measuring unit 26, and the output unit 27 are provided by a computer processor (for example, CPU (Central Processing Unit), GPU (Graphics Processing Unit) operating according to the program (appearance inspection program).

For example, a program may be stored in the storage unit 21, and the processor may read the program and, according to the program, operate the input unit 22, the conversion equation calculation unit 23, the defect area extraction unit 24, the defect type determination unit 25, the defect measuring unit 26, and the output unit 27. In addition, the functions of the appearance inspection device 20 may be provided in SaaS (Software as a Service) format.

The input unit 22, the conversion equation calculation unit 23, the defect area extraction unit 24, the defect type determination unit 25, the defect measuring unit 26, and the output unit 27 may each be realized by dedicated hardware. In addition, some or all of the components of each device may be realized by a general-purpose circuit (circuitry) or a dedicated circuit, a processor, etc., or a combination of these. They may be configured by a single chip or by multiple chips connected via a bus. Some or all of the components of each device may be realized by a combination of the above-mentioned circuits, etc. and programs.

In the case where some or all of the components of the appearance inspection device 20 are realized by a plurality of information processing devices, circuits, or the like, the plurality of information processing devices, circuits, or the like may be centrally located or distributed. For example, the information processing devices, circuits, etc. may be realized as an embodiment where each of which is connected via a communication network, such as a client-server system, a cloud computing system, etc.

The storage unit 21 is realized by, for example, a magnetic disk, etc.

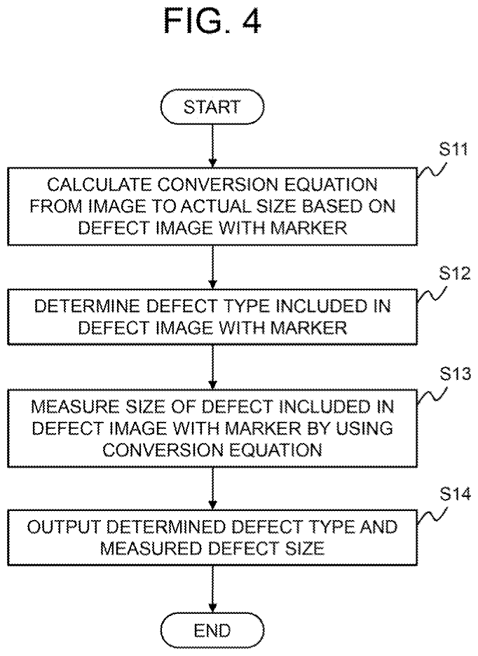

Next, an operation example of this exemplary embodiment will be described. FIG. 4 is a flowchart showing an operation example of the appearance inspection device of this exemplary embodiment.

When the input unit 22 receives the input of the defect image with marker, the conversion equation calculation unit 23 calculates the conversion equation from the image to the actual size based on the defect image with marker (step S11). The defect type determination unit 25 determines the type of defect included in the defect image with marker by using a model for determining the type of defect from the image (step S12). The defect type determination unit 25 may determine the type of defect for the image including the defect part extracted by the defect area extraction unit 24 as a target.

The defect measuring unit 26 measures the defect size included in the defect image with marker by using a conversion equation (step S13). Then, the output unit 27 outputs the determined defect type and the measured defect size (step S14).

As described above, in this exemplary embodiment, the conversion equation calculation unit 23 calculates a conversion equation based on a defect image with marker, and the defect type determination unit 25 determines the defect type included in the defect image with marker by using a model for determining a type of defect from the image. The defect measuring unit 26 measures the defect size included in the defect image with marker by using the conversion equation, and the output unit 27 outputs the determined defect type and the measured defect size. Therefore, it is possible to reduce the man-hours for inspect the contents of defects occurred in the appearance of an object to be inspected from images including defects that can be obtained by a simple method. In addition, since the determination criteria are clarified compared to the vague confirmation by human hands in the past, it is also possible to reduce unnecessary repairs for defects occurred in the appearance.

### Exemplary Embodiment 2

Next, the second exemplary embodiment of the appearance inspection device according to the present invention is described. The second exemplary embodiment automatically determines the subsequent correspondence from the contents of the obtained defect (type and size of the defect).

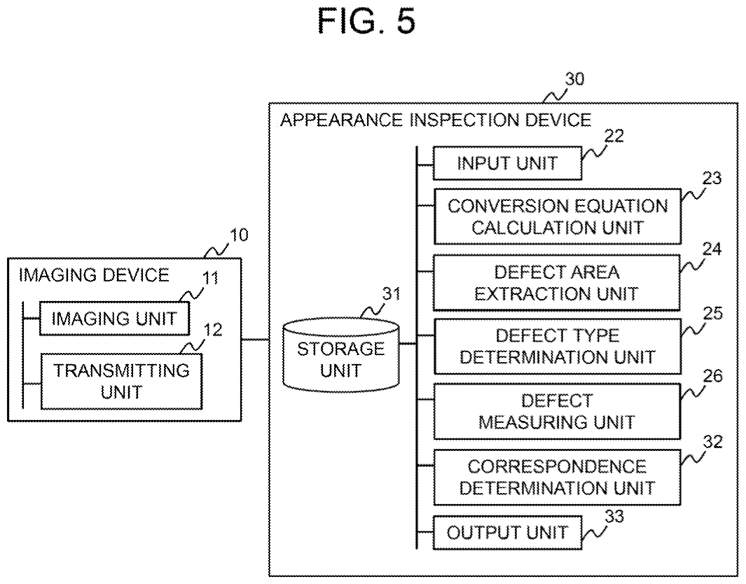

FIG. 5 is a block diagram showing a configuration example of the second exemplary embodiment of an appearance inspection device according to the present invention. As in the first exemplary embodiment, an appearance inspection device 30 of this exemplary embodiment is connected to the imaging device 10 via a communication network.

The appearance inspection device 30 includes a storage unit 31, the input unit 22, the conversion equation calculation unit 23, the defect area extraction unit 24, the defect type determination unit 25, the defect measuring unit 26, a correspondence determination unit 32, and an output unit 33. In other words, the appearance inspection device 30 of this exemplary embodiment is different compared to the appearance inspection device 20 of the first exemplary embodiment, in terms of further including the correspondence determination unit 32 and including the storage unit 31 and the output unit 33 instead of the storage unit 21 and the output unit 27.

In addition to the contents stored by the storage unit 21 of the first exemplary embodiment, the storage unit 31 stores a rule master that defines a countermeasure to the defect type and the defect size. For example, when the object to be inspected is an automobile, the countermeasure may be the contents of the manufacturer's warranty for the defect (for example, whether the manufacturer warrants the defect and pays the dealer for repair correspondence, etc.). The warranty contents are predetermined according to the defect type and the defect size. This rule master may also be defined for each object to be inspected and for each corresponding person.

Furthermore, the storage unit 31 may store a defect occurrence master that associates the occurrence process with each type of defect. For example, in the case of an automobile, if the defect is a line flaw; it can be determined that the defect occurred during the transportation process (during transportation of the vehicle from the factory to the dealer), and if the defect is a dust bite (seeds) or uneven painting, it can be determined that the defect occurred during the manufacturing process. These associations may be held in the defect master.

The correspondence determination unit 32 determines the countermeasure according to the type of output defect and the size of the defect, based on the rule master stored in the storage unit 31.

The output unit 33 outputs the determined countermeasure in addition to the output content by the output unit 27 of the first exemplary embodiment. The output unit 33 may also output the defect occurrence process based on the type of defect on the basis of the defect occurrence master. This makes it possible to improve the occurrence process.

The input unit 22, the conversion equation calculation unit 23, the defect area extraction unit 24, the defect type determination unit 25, the defect measuring unit 26, the correspondence determination unit 32, and the output unit 33 are realized by a computer processor operating according to a program (appearance inspection program). In addition, the storage unit 31 is realized by such as a magnetic disk, for example.

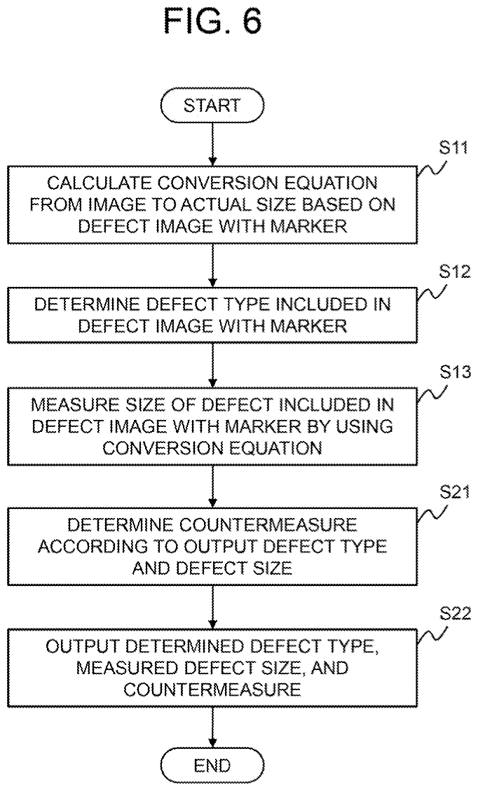

Next, an operation example of this exemplary embodiment will be described. FIG. 6 is a flowchart showing an operation example of the appearance inspection device of this exemplary embodiment. The processing from step S11 to step S13, until the input unit 22 receives the input of a defect image with marker, determines the defect type, and measures the defect size, is the same as the operation illustrated in FIG. 4

Based on the rule master stored in the storage unit 31, the correspondence determination unit 32 determines the countermeasure according to the output defect type and defect size (step S21). Then, the output unit 27 outputs the determined defect type, the measured defect size, and the countermeasure (step S22).

As described above, in this exemplary embodiment, the correspondence determination unit 32 determines the countermeasure according to the output defect type and defect size based on the rule master. Therefore, in addition to the effect of the first exemplary embodiment, it is possible to automate the decision-making process for defects.

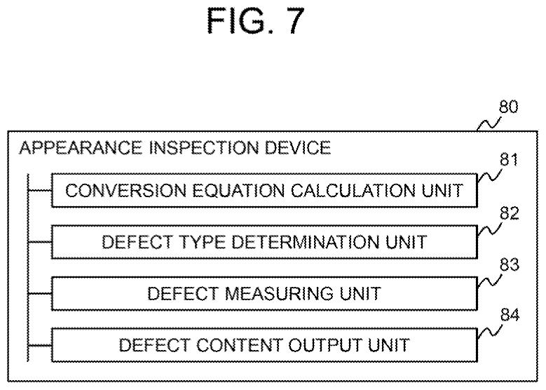

Next, an overview of the present invention will be described. FIG. 7 is a block diagram showing an overview of the appearance inspection device according to the present invention. An appearance inspection device 80 (for example, the appearance inspection device 20) according to the present invention includes a conversion equation calculation unit 81 (for example, the conversion equation calculation unit 23) which calculates, based on a defect image with marker in which a marker (for example, the markers 41 to 44 as illustrated in FIG. 2) of a predetermined size that can be recognized regardless of color (for example, body color of the automobile, painted color) of appearance of an object to be inspected (for example, the automobile) and a defect (for example, scratches, dust bites, uneven colors, etc.) of the object to be inspected are taken, a conversion equation from size of the defect image with marker to actual size, a defect type determination unit 82 (for example, the defect type determination unit 25) which determines, by using a model for detecting the defect of the object to be inspected from an image and determining a defect type, the defect type included in the defect image with marker, a defect measuring unit 83 (for example, the defect measuring unit 26) which measures defect size included in the defect image with marker by using the conversion equation, and a defect content output unit 84 (for example, the output unit 27) which outputs the determined defect type and the measured defect size.

With such a configuration, it is possible to reduce the man-hours for inspect the contents of defects occurred in the appearance of an object to be inspected from images including defects that can be obtained by a simple method. In addition, since the determination criteria are clarified compared to the vague confirmation by human hands in the past, it is also possible to reduce unnecessary repairs for defects occurred in the appearance.

The defect image with marker is an image taken with a marker attached in the vicinity of the defect, and the appearance inspection device 80 may include a defect area extraction unit (for example, the defect area extraction unit 24) which extracts from the defect image with marker an image that includes a marker and is within a predetermined area from the marker as the image including a defect part. The defect type determination unit 82 may then determine the defect type included in the extracted image. With such a configuration, it is possible to improve the accuracy of determining the defect type.

The appearance inspection device 80 (for example, the appearance inspection device 30) may include a rule master storage unit (for example, the storage unit 31) which stores a rule master that defines the countermeasure to the defect type and the defect size, and a correspondence determination unit (for example, the correspondence determination unit 32) which determines the countermeasure according to the output defect type and defect size based on the rule master. With such a configuration, it is possible to automate the decision-making process for defects.

The defect content output unit 84 (for example, the output unit 33) may output defect generation process based on the defect type.

Specifically, the marker may be formed in such a way that two or more colors are used, and at least two colors each can be used to identify part or all of a square or a circle.

The appearance inspection device 80 may include an input unit (for example, the input unit 22) which receives input of the defect image with marker from an imaging device (for example, the imaging device 10) that takes the defect image with marker including the marker and the object to be inspected according to user's operation.

While the present invention has been explained with reference to the exemplary embodiments and examples, the present invention is not limited to the aforementioned exemplary embodiments and examples. Various changes understandable to those skilled in the art within the scope of the present invention can be made to the structures and details of the present invention.

This application claims priority based on Japanese patent application 2019-192625, filed on Oct. 23, 2019, the entire disclosure of which is hereby incorporated herein.

### REFERENCE SIGNS LIST

10 Imaging device
11 Imaging unit
12 Transmitting unit
20, 30 Appearance inspection device
21, 31 Storage unit
22 Input unit
23 Conversion equation calculation unit
24 Defect area extraction unit
25 Defect type determination unit
26 Defect measuring unit
27, 33 Output unit
32 Correspondence determination unit

What is claimed is:

1. An appearance inspection device comprising:
a memory storing instructions; and
one or more processors configured to execute the instructions to:
calculate a conversion equation from size of a defect image with marker to actual size, the defect image with marker being an image taken of a marker of a predetermined size that can be recognized regardless of color of appearance of an object to be inspected and taken of a defect of the object to be inspected;
determine a defect type included in the defect image with marker by using a model for detecting the defect of the object to be inspected from an image and determining the defect type;
measure defect size included in the defect image with marker by using the conversion equation; and
output the determined defect type and the measured defect size.

2. The appearance inspection device according to claim 1, wherein
the defect image with marker is an image taken with a marker attached in the vicinity of the defect, and the processor further executes instructions to:
extract from the defect image with marker an image including a defect part, the extracted image including the marker and being within a predetermined area from the marker part; and
determine the defect type included in the extracted image.

3. The appearance inspection device according to claim 1, further comprising
a rule master storage which stores a rule master that defines a countermeasure to the defect type and the defect size,
wherein the processor further executes instructions to determine the countermeasure according to the output defect type and defect size based on the rule master.

4. The appearance inspection device according to claim 1, wherein the processor further executes instructions to
output defect generation process based on the defect type.

5. The appearance inspection device according to claim 1, wherein
the marker is formed by at least a square or a circle and includes at least two colors each of which identify part or all of the square or the circle.

6. The appearance inspection device according to claim 1, wherein the processor further executes instructions to
receive input of the defect image with marker from an imaging device that takes the defect image with marker including the marker and the object to be inspected according to user's operation.

7. An appearance inspection method comprising:
calculating a conversion equation from size of a defect image with marker to actual size, the defect image with marker being an image taken of a marker of a predetermined size that can be recognized regardless of color of appearance of an object to be inspected and taken of a defect of the object to be inspected;
determining a defect type included in the defect image with marker by using a model for detecting the defect of the object to be inspected from an image and determining the defect type;
measuring defect size included in the defect image with marker by using the conversion equation; and
outputting the determined defect type and the measured defect size.

8. The appearance inspection method according to claim 7, wherein
the defect image with marker is an image taken with a marker attached in the vicinity of the defect, and further comprising:
extracting from the defect image with marker an image including a defect part, the extracted image including the marker and being within a predetermined area from the marker; and
determining the defect type included in the extracted image.

9. A non-transitory computer readable information recording medium storing an appearance inspection program, when executed by a processor, the appearance inspection program performs a method for:
calculating a conversion equation from size of a defect image with marker to actual size, the defect image with marker being an image taken of a marker of a predetermined size that can be recognized regardless of color of appearance of an object to be inspected and taken of a defect of the object to be inspected;
determining a defect type included in the defect image with marker by using a model for detecting the defect of the object to be inspected from an image and determining the defect type;
measuring defect size included in the defect image with marker by using the conversion equation; and
outputting the determined defect type and the measured defect size.

10. The non-transitory computer readable information recording medium according to claim 9,
wherein the defect image with marker is an image taken with a marker attached in the vicinity of the defect, and further comprising:
extracting from the defect image with marker an image including a defect part, the extracted image including the marker and being within a predetermined area from the marker; and
determining the defect type included in the extracted image.
